(19) United States
(12) Patent Application Publication
(10) Pub. No.: US 2008/0024626 A1
(43) Pub. Date: Jan. 31, 2008

(54) IMAGE CAPTURING APPARATUS

(75) Inventor: Yasuhiro YAMAMOTO, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/782,269

(22) Filed: Jul. 24, 2007

(30) Foreign Application Priority Data
Jul. 26, 2006 (JP) 2006-203076

(51) Int. Cl. H04N 5/76

(52) U.S. Cl. 348/231.2; 348/E05.024

(57) ABSTRACT

An image capturing apparatus is provided having an image capturing device, an image compressing device, a recording device, a definition calculating device, and a residual recordable number calculating device. The image capturing device outputs a captured image. The image compressing device compresses the captured image using flexible compression. The recording device records the compressed captured image into a memory medium. The residual recordable number calculating device calculates a residual recordable number of images in the memory medium from a residual recordable amount of the memory medium and file size which is decided according to the photographing configuration.

### BACKGROUND OF THE INVENTION

1. Field of the Invention

The present invention relates to an image capturing apparatus, and particularly to a prediction of the residual recordable number of images in a storage medium provided in the image capturing apparatus.

2. Description of the Related Art

An image capturing apparatus, e.g. a digital camera, captures an object image through a lens and converts it into images data using a CCD and an AFE. The image data is stored temporarily in a memory which is provided in the digital camera, processed by a DSP, and recorded into an external memory medium as an image file. An LCD automatically or manually displays an image file which is stored in a memory medium, a moving image (a monitor-through image) transmitted from a CCD, and information required for operating the digital camera.

A DSP creates an image file using JPEG compression. JPEG compression is a type of flexible compression which results in image files differing from each other in size.

The concept that the residual recordable amount in a storage medium is divided by a fixed value to predict the residual recordable number of images is disclosed in Japanese Unexamined Patent Publication (KOKAI) No. 2002-290779.

### SUMMARY OF THE INVENTION

An object of the present invention is to provide an image capturing apparatus which accurately calculates the residual recordable number of images in a storage medium provided in a digital camera.

An image capturing apparatus is provided having an image capturing device, an image compressing device, a recording device, a definition calculating device, and a residual recordable number calculating device. The image capturing device outputs a captured image. The image compressing device compresses the captured image using flexible compression. The recording device records the compressed captured image into a memory medium. The residual recordable number calculating device calculates a residual recordable number of images in the memory medium from a residual recordable amount of the memory medium, and file size which is decided according to the photographing configuration.

### BRIEF DESCRIPTION OF THE DRAWINGS

The objects and advantages of the present invention will be better understood from the following description, with reference to the accompanying drawings in which:

FIG. 1 is a block diagram showing the digital camera as an embodiment of the present invention;

FIG. 2 is a graph showing the relationship between ISO speed and file size; and

FIG. 3 is a flowchart showing the residual recordable number calculating process.

### DESCRIPTION OF THE PREFERRED EMBODIMENTS

The present invention is described below with reference to the embodiments shown in the drawings.

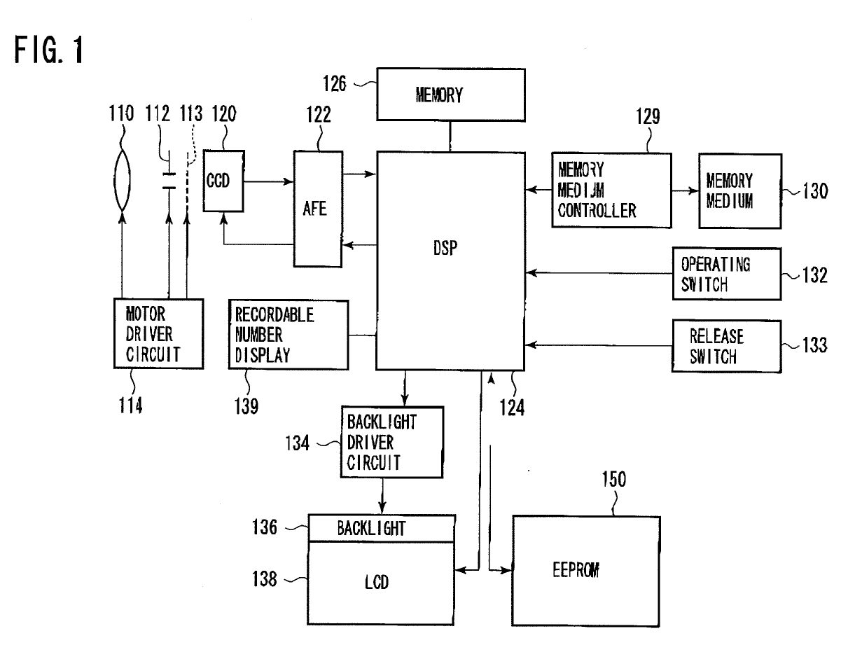

The constitution of a digital camera having a image capturing apparatus is described with reference to FIG. 1.

A photographing object image is provided on a CCD 120 through a lens 110, an aperture 112, and a shutter 113. The lens 110, the aperture 112, and the shutter 113 are operated by a motor driving circuit 114 according to a control signal from a DSP 124. When the shutter 113 is closed by operating a release switch 133, the CCD 120 converts the photographing object image into electrical signals. An AFE 122 amplifies electrical signals and converts them into image data. The DSP 124 receives the image data, stores it temporarily in a memory 126, and creates an image file by processing and compressing the image data. The created image file is recorded into a memory medium 130 through a memory medium controller 129. An EEPROM 150 stores various data and programs which are required to operate the DSP 124. An operating switch is provided for operating the digital camera, e.g. displaying an image recorded in the memory medium 130. A user configures the ISO speed and pixel size using the operating switch 132.

A backlight driving circuit 134 turns on a backlight provided in an LCD 138 according to a control signal from the DSP 124. The LCD 138 displays a monitor-through image which is created by periodically updating the image data received from the DSP 120 before an object is photographed, and displays image files recorded into the memory medium 130 after an object is photographed. Additionally, the LCD 138 can display the residual recordable number of images in the memory medium 130. Further, a recordable number display 139 also displays the residual recordable number of images in the memory medium 130.

The amplification factor of the AFE 122, i.e. the gain, is decided using the ISO speed which is configured by a user with the operating switch 132. When the ISO speed is raised, the gain is increased, and consequently noise in an image is also increased. This decreases the S/N ratio, and increases the occurrence of areas in which brightness or color tone precipitously changes, i.e. higher frequency components in an image are increased.

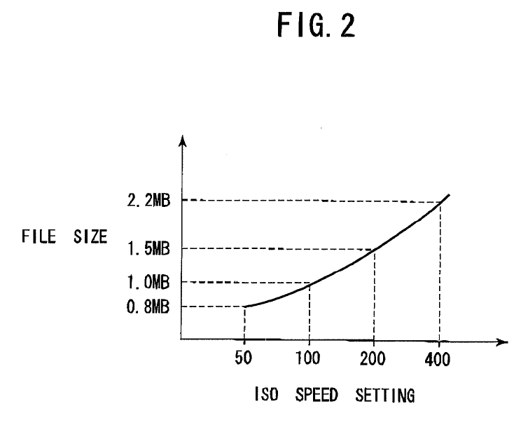

FIG. 2 is a graph showing the relationship between ISO speed and estimated file size of a compressed image file. A compressed image file is captured at, for example, approximately 5 M pixel resolution, e.g. a resolution of 2560×1920 pixels.

The estimated file size of a compressed image file is found from the average size of various image files which were created by capturing various photographing objects. A similar graph can be drawn for each resolution at which a digital camera is able to photograph.

Compression is executed using the JPEG compression method. The JPEG compression method comprises a discrete cosine transform process, a quantization process, and a Huffman encoding process. The discrete cosine transform process is a kind of orthogonal transform coding. In a discrete cosine transform process and a quantization process, pixel information is unevenly distributed to the lower frequency components, and higher frequency components are rounded off because they occur less in a natural image, i.e. the brightness or color tone in a natural image doom not precipitously change. A Huffman encoding process compresses data using event probability of the data. Therefore, in the case that the gain is increased by raising the ISO speed, higher frequency components in image data output from the AFE 122 is increased. In the case that higher frequency components are increased, the file size of the compressed image data is also increased because the Image data is compressed inefficiently.

Referring to FIG. 2, in the case that the ISO speed is 50, image data is compressed efficiently because a higher S/N ratio decreases higher frequency components. The estimated file size is approximately 0.8 MB in this case. On the other hand, if the ISO speed is 400, image data is compressed inefficiently because a lower S/N ratio increases higher frequency components. The estimated file size is approximately 2.2 MB in this case.

The EEPROM 150 stores table data which represents the relationship between ISO speed and file size for each pixel size of an image. The table data is created according to the graph shown in FIG. 2. The DSP 124 refers to the table data, and calculates the estimated file size which corresponds to the photographing setting.

The estimated file size, which is approximately the file size of a photographed image file, is obtained by using the graph shown in FIG. 2.

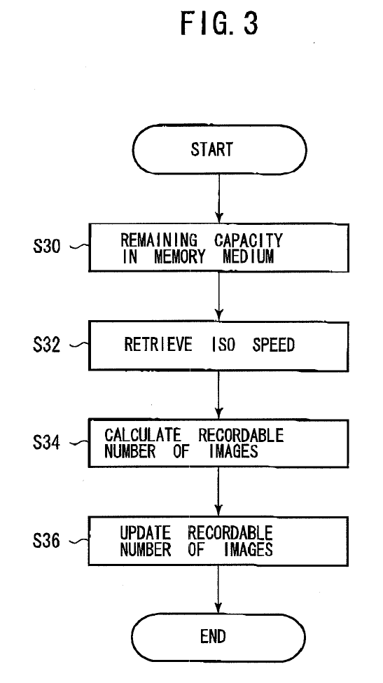

The residual recordable number display process is described reference to FIG. 3. The residual recordable number display process calculates the residual recordable number of images, and displays it on the LCD 138 and/or the recordable number display 139.

When the digital camera is powered on, a residual recordable number display process is executed. The DSP 124 calculates the remaining recordable capacity in a memory medium with the memory medium controller 129 in step S30, and retrieves the ISO speed as configured by a user in step s32.

In step S34, a residual recordable number calculating process is executed. The DSP 124 retrieves the estimated file size, which is decided using table data created according to the ISO speed and pixel size of an image. The table data is stored in the EEPROM 150. The residual recordable number of images equals the remaining recordable amount of a memory medium divided by the estimated file size. According to this process, a residual recordable number of images is calculated with a high degree of accuracy.

In step S36, the LCD 138 and/or the recordable number display 139 displays the residual recordable number of images, and a user is able to see an accurate residual recordable number of images.

According to this embodiment, the residual recordable number of images is accurately calculated. The time needed for calculation is shortened by using table data stored in the EEPROM 150.

Note that the estimated file size may be calculated using other factors which change the file size of a compressed image file, in addition to pixel size and ISO speed.

The estimated file size may be calculated using a function of pixel size and ISO speed.

The residual recordable number calculating process may be executed after compressed image data is recorded in the memory medium 130. A user can see an accurate residual recordable number of images when the remaining recordable amount in the memory medium is changed.

The residual recordable number calculating process may be executed after a configuration of ISO speed and pixel size is changed. When the configuration of ISO speed and pixel count is changed, the estimated file size is changed. A user can see an accurate residual recordable number of images when the configuration of ISO speed and pixel size is changed.

Moreover, the memory medium 130 may be a detachable memory card, e.g. SD card™, or any storage medium provided in a digital camera.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2006-203076 (filed on Jul. 26, 2006), which is expressly incorporated herein, by reference, in its entirety.

1. An image capturing apparatus comprising:
an image capturing device that outputs a captured image:
an image compressing device that compresses the captured image using flexible compression;
a recording device that records the compressed captured image into a memory medium; and
a residual recordable number calculating device that calculates a residual recordable number of images in the memory medium from a residual recordable amount of the memory medium and a file size which is decided according to the photographing configuration.

2. The image capturing apparatus according to claim 1, wherein the photographing configuration comprises a pixel size of the captured image.

3. The image capturing apparatus according to claim 1, wherein the photographing configuration comprises the gain of said image capturing device.

4. The image capturing apparatus according to claim 1, wherein the photographing configuration comprises the ISO speed.

5. The image capturing apparatus according to claim 1, wherein said residual recordable number calculating device calculates the residual recordable number of images when the image capturing apparatus is powered on.

6. The image capturing apparatus according to claim 2, wherein said residual recordable number calculating device calculates the residual recordable number of images when the pixel size of the captured image is changed.

7. The image capturing apparatus according to claim 3, wherein said residual recordable number calculating device calculates the residual recordable number of images when the gain is changed.

8. The image capturing apparatus according to claim 4, wherein said residual recordable number calculating device calculates the residual recordable number of images when the ISO speed is changed.

9. The image capturing apparatus according to claim 1, wherein the file size is decided according to the photographing configuration in advance, and is stored in said residual recordable number calculating device.

10. The image capturing apparatus according to claim 1, further comprising a display that displays the residual recordable number of images.

11. The image capturing apparatus according to claim 7, wherein said residual recordable number calculating device decreases the residual recordable number of images when the gain is increased.

12. The image capturing apparatus according to claim 8, wherein said residual recordable number calculating device decreases the residual recordable number of images when the ISO speed is raised.
